(19) United States
(12) Patent Application Publication
(10) Pub. No.: US 2025/0373899 A1
(43) Pub. Date: Dec. 4, 2025

(54) SYNCHRONIZED OPERATION REPLAY INTERFACE

(71) Applicant: Tencent Technology (Shenzhen) Company Limited, Shenzhen (CN)

(72) Inventors: Zhiyong WANG, Shenzhen (CN); Kunli DENG, Shenzhen (CN); Canhui HUANG, Shenzhen (CN); Yifei BAI, Shenzhen (CN)

(73) Assignee: Tencent Technology (Shenzhen) Company Limited, Shenzhen, GD (CN)

(21) Appl. No.: 19/296,728

(22) Filed: Aug. 11, 2025

Related U.S. Application Data
(63) Continuation of application No. PCT/CN2024/096952, filed on Jun. 3, 2024.

(30) Foreign Application Priority Data
Jul. 28, 2023 (CN) 202310944116.X

(51) Int. Cl. H04N 21/472; H04N 21/431

(52) U.S. Cl. CPC H04N 21/47217; H04N 21/4312

(57) ABSTRACT

An operation replay interface including an operation video replay area and an operation event list is output for display. The operation video replay area includes the operation replay video and a playback progress bar. Operation events are displayed in the operation event list. Display of the operation events is synchronized with the playback progress bar. When a first trigger operation is performed on the playback progress bar, a playback indicator is positioned at a first playback time point indicated by the first trigger operation. A display attribute of a first operation event corresponding to the first playback time point is changed. When a second trigger operation is performed on a second operation event in the operation event list, a display attribute of the second operation event in the operation event list is changed. The playback indicator is positioned at a second playback time point corresponding to the second operation event.

### RELATED APPLICATIONS

The present application is a continuation of International Application No. PCT/CN2024/096952, filed on Jun. 3, 2024, which claims priority to Chinese Patent Application No. 202310944116.X, filed on Jul. 28, 2023. The entire disclosures of the prior applications are hereby incorporated by reference.

### FIELD OF THE TECHNOLOGY

This application relates to the field of data analysis technologies, including an operation data display method.

### BACKGROUND OF THE DISCLOSURE

To check operation data through replay, a corresponding operation replay video is often regenerated based on the operation data, and each operation event is observed more visually through the operation replay video.

In related art, a playback time point of the operation replay video can be adjusted only by clicking/tapping a video progress bar, and the playback time point of the operation replay video cannot be positioned based on the operation event. Consequently, during watching of the operation replay video, switching needs to be performed back and forth between the video progress bar and an operation event list, to determine an operation event corresponding to a current playback time point, resulting in a problem of cumbersome and time-consuming operations.

### SUMMARY

Aspects of this disclosure provide an operation data display method, an apparatus, and a non-transitory computer-readable storage medium, which can enrich an operation data display manner and improve operation data display efficiency.

Examples of technical solutions of this disclosure may be implemented as follows:

An aspect of this disclosure provides a method for replaying user operation events. An operation event sequence is obtained during execution of an application. An operation replay video is generated based on user operations indicated by the operation event sequence. An operation replay interface including an operation video replay area and an operation event list of the operation event sequence is output for display. The operation video replay area includes the operation replay video and a playback progress bar. Operation events are displayed in the operation event list. Display of the operation events in the operation event list is synchronized with the playback progress bar. Based on a first trigger operation being performed on the playback progress bar, a playback indicator of the playback progress bar is positioned at a first playback time point indicated by the first trigger operation. In the operation event list, a display attribute of a first operation event that corresponds to the first playback time point is changed. The operation replay video is played back at the first playback time point. Based on a second trigger operation being performed on a second operation event in the operation event list, a display attribute of the second operation event in the operation event list is changed. The playback indicator of the playback progress bar is positioned at a second playback time point corresponding to the second operation event.

An aspect of this disclosure provides an apparatus for replaying user operation events. The apparatus including processing circuitry configured to obtain an operation event sequence during execution of an application. The processing circuitry is configured to generate an operation replay video based on user operations indicated by the operation event sequence. The processing circuitry is configured to output for display an operation replay interface including an operation video replay area and an operation event list of the operation event sequence. The operation video replay area includes the operation replay video and a playback progress bar. Operation events are displayed in the operation event list. Display of the operation events in the operation event list is synchronized with the playback progress bar. Based on a first trigger operation being performed on the playback progress bar, the processing circuitry is configured to position a playback indicator of the playback progress bar at a first playback time point indicated by the first trigger operation. The processing circuitry is configured to change, in the operation event list, a display attribute of a first operation event that corresponds to the first playback time point. The processing circuitry is configured to play back the operation replay video at the first playback time point. Based on a second trigger operation being performed on a second operation event in the operation event list, the processing circuitry is configured to change a display attribute of the second operation event in the operation event list. The processing circuitry is configured to position the playback indicator of the playback progress bar at a second playback time point corresponding to the second operation event.

An aspect of this disclosure provides an operation data display method, the method including: displaying an operation replay interface, the operation replay interface being configured to display operation data generated in a program testing process, the operation replay interface including an operation video replay area and an operation event list, the operation video replay area displaying an operation replay video and a playback progress bar, the operation replay video being generated by simulating a user operation based on an operation event sequence, an operation event included in the operation event sequence being displayed in the operation event list, and the playback progress bar being positioned in association with the operation event in the operation event list; causing, in response to a first trigger operation on the playback progress bar, the operation replay video to jump to a first operation interface, and marking, in the operation event list, a first operation event corresponding to a first playback time point, the first operation interface being an operation interface corresponding to the first playback time point indicated by the first trigger operation; and marking, in response to a second trigger operation on a second operation event in the operation event list, the second operation event, and positioning the playback progress bar to a second playback time point corresponding to the second operation event.

An aspect of this disclosure provides an operation data display apparatus, the apparatus including: a first display module, configured to display an operation replay interface, the operation replay interface being configured to display operation data generated in a program testing process, the operation replay interface including an operation video replay area and an operation event list, the operation video replay area displaying an operation replay video and a playback progress bar, the operation replay video being generated by simulating a user operation based on an operation event sequence, an operation event included in the operation event sequence being displayed in the operation event list, and the playback progress bar being positioned in association with the operation event in the operation event list; a second display module, configured to cause, in response to a first trigger operation on the playback progress bar, the operation replay video to jump to a first operation interface, and mark, in the operation event list, a first operation event corresponding to a first playback time point, the first operation interface being an operation interface corresponding to the first playback time point indicated by the first trigger operation; and a third display module, configured to mark, in response to a second trigger operation on a second operation event in the operation event list, the second operation event, and position the playback progress bar to a second playback time point corresponding to the second operation event.

In a possible implementation, the second display module is configured to: determine, in response to the first trigger operation on the playback progress bar, the first playback time point corresponding to the first trigger operation on the playback progress bar; determine the first operation event based on the first playback time point and the operation event sequence, and mark the first operation event in the operation event list; and cause the operation replay video to jump to the first operation interface based on the first playback time point and the first operation event, the first operation interface corresponding to the first operation event.

In a possible implementation, the second display module is further configured to: determine the first operation event from the operation event sequence though binary search based on the first playback time point and a time stamp corresponding to the operation event sequence, the time stamp representing a playback time point corresponding to each operation event in the operation event sequence; and mark the first operation event in the operation event list and each operation event occurring before the first operation event.

In a possible implementation, the third display module is configured to: mark, in response to the second trigger operation on the second operation event in the operation event list, the second operation event and each operation event in the operation event list that occurs before the second operation event; determine a second playback time point corresponding to the second operation event based on the second operation event and the time stamp corresponding to the operation event sequence, the time stamp representing a playback time point corresponding to each operation event in the operation event sequence; and position the playback progress bar to the second playback time point corresponding to the second operation event.

In a possible implementation, the third display module is further configured to: cause the operation replay video to jump to a second operation interface based on the second playback time point and the second operation event, the second operation interface corresponding to the second operation event; and adjust a display progress of the playback progress bar based on the second playback time point and a total playback duration of the operation replay video, the display progress being positively correlated with a playback duration of the operation replay video.

In a possible implementation, the first display module is configured to: obtain the operation event sequence in a case that a third trigger operation on an operation replay control is received; simulate the user operation on an application interface based on the operation event sequence, generating the operation replay video, and display the operation replay video in the operation video replay area on the operation replay interface; display the playback progress bar in the operation video replay area based on the total playback duration corresponding to the operation replay video; and sort operation events in the operation event sequence in chronological order of operations based on the operation time sequence, and display the operation events in the operation event list on the operation replay interface.

In a possible implementation, the first display module is further configured to: screen the operation events in the operation event sequence, to obtain a screened operation event, the screened operation event including an interface change event and a control interaction event, the interface change event being an operation event that generates an interface jump, and the control interaction event being an event that implements interface interaction based on a trigger operation on a control; and sort the screened operation events in chronological order of operations, and display the screened operation events in the operation event list.

In a possible implementation, the apparatus further includes: a level division module, configured to hierarchically divide an application operation interface based on the operation event sequence, to obtain a multi-level application operation interface, an application control in an i^{th} level application operation interface being triggered to jump to an (i+1)^{th} level application operation interface; an event division module, configured to divide, based on the multi-level application operation interface obtained through division, the operation events in the operation event list, and determine, as an i^{th} level operation event, an operation event executed in the i^{th} level application operation interface; and a fourth display module, configured to hierarchically display, in the operation event list, an (i+1)^{th} level operation event below the i^{th} level operation event.

In a possible implementation, the apparatus further includes: a playback jumping module, configured to cause, in response to a fourth trigger operation on the i^{th} level operation event, the operation replay video to jump to a third operation interface corresponding to the i^{th} level operation event; and a fifth display module, configured to display, on the playback progress bar, an (i+1)^{th} level playback marking point corresponding to the (i+1)^{th} level operation event corresponding to the i^{th} level operation event.

The playback jumping module is further configured to cause, in response to a fifth trigger operation on the (i+1)^{th} level playback marking point, the operation replay video to jump to a fourth operation interface corresponding to the (i+1)^{th} level operation event.

In a possible implementation, the apparatus further includes: a grouping module, configured to group the operation events based on the operation event sequence and an operation event type, to obtain an operation event grouping result, operation events of the same type in the operation event grouping result being grouped together; a sixth display module, configured to display an event group in the operation event list based on the operation event grouping result; and a seventh display module, configured to expand and display, in response to a sixth trigger operation on a first event group, each operation event in the first event group in the operation event list.

In a possible implementation, the apparatus further includes: a screening module, configured to screen the operation events for a control interaction event based on the operation event sequence, the control interaction event being an event that implements interface interaction based on a trigger operation on a control; an eighth display module, configured to display a corresponding control code positioning button in the control interaction event in the operation event list; and a ninth display module, configured to jump and display, in response to a seventh trigger operation on a first control code positioning button, a first control code segment corresponding to the first control code positioning button in a sequence code corresponding to the operation event sequence.

In a possible implementation, a sequence switching button is further displayed on the operation video replay area. The apparatus further includes: a switching display module, configured to switch and display, in response to an eighth trigger operation on the sequence switching button, the operation replay video in the operation video replay area, and switch and display the operation event in the operation event list.

An aspect of this disclosure provides a computer device. The computer device includes a processor and a memory. The memory has at least one computer instruction stored therein, the at least one computer instruction being configured for being executed by the processor, to implement the operation data display method in the foregoing aspects.

An aspect of this disclosure provides a non-transitory computer-readable storage medium, having computer-executable instructions stored therein, the computer-executable instructions, when executed by a processor, cause the processor to implement the operation data display method in the foregoing aspects.

An aspect of this disclosure provides a computer program product, the computer program product including computer-readable instruction, the computer instruction being stored in a computer-readable storage medium. A processor of a computer device reads the computer instruction from the computer-readable storage medium, and the processor executes the computer instruction, to cause the computer device to perform the operation data display method provided in various implementations of the foregoing aspects.

In the aspects of this disclosure, the operation data generated in the program testing process is displayed through the operation replay interface. The operation replay interface includes the operation video replay area and the operation event list. The operation replay video and the playback progress bar are displayed in operation video replay area. The operation event is displayed in the operation event list, and the playback progress bar is positioned in association with the operation event. In this way, in a case that the first trigger operation on the playback progress bar is received, the operation replay video may be jumped to the first operation interface corresponding to the first playback time point specified by the first trigger operation. The first operation event corresponding to the first playback time point in the operation event list may further be marked. In a case that the second trigger operation performed on the second operation event in the operation event list is received, the second operation event can be marked, and the playback progress bar may further be positioned to the second playback time point corresponding to the second operation event. In this way, jumping the operation replay video is implemented, bidirectional association positioning between the operation event list and the playback progress bar is implemented, an operation data display effect is optimized, an operation data display manner is enriched, and operation data display efficiency is improved. The user does not need to switch between the video progress bar and the operation event list, and can directly determine the operation event corresponding to a current playback time point, which is simpler in operation and consumes less time.

### BRIEF DESCRIPTION OF THE DRAWINGS

FIG. 1 is a schematic diagram of an implementation environment according to an aspect of this disclosure.

FIG. 2 is a flowchart of an operation data display method according to an aspect of this disclosure.

FIG. 3 is a schematic diagram of an operation replay interface according to an aspect of this disclosure.

FIG. 4 is a flowchart of an operation data display method according to another aspect of this disclosure.

FIG. 5 is a schematic diagram of an operation replay interface in response to a first trigger operation on a playback progress bar according to an aspect of this disclosure.

FIG. 6 is a schematic diagram of an operation replay interface in response to a second trigger operation on a second operation event according to an aspect of this disclosure.

FIG. 7 is a schematic diagram of an operation replay interface for hierarchically displaying operation events according to an aspect of this disclosure.

FIG. 8 is a structural block diagram of an operation data display apparatus according to an aspect of this disclosure.

FIG. 9 is a schematic structural diagram of a computer device according to an aspect of this disclosure.

### DETAILED DESCRIPTION

To make objectives, technical solutions, and advantages of this disclosure clearer, implementations of this disclosure are described in further detail with reference to drawings. Further, the descriptions of the terms are provided as examples only and are not intended to limit the scope of the disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

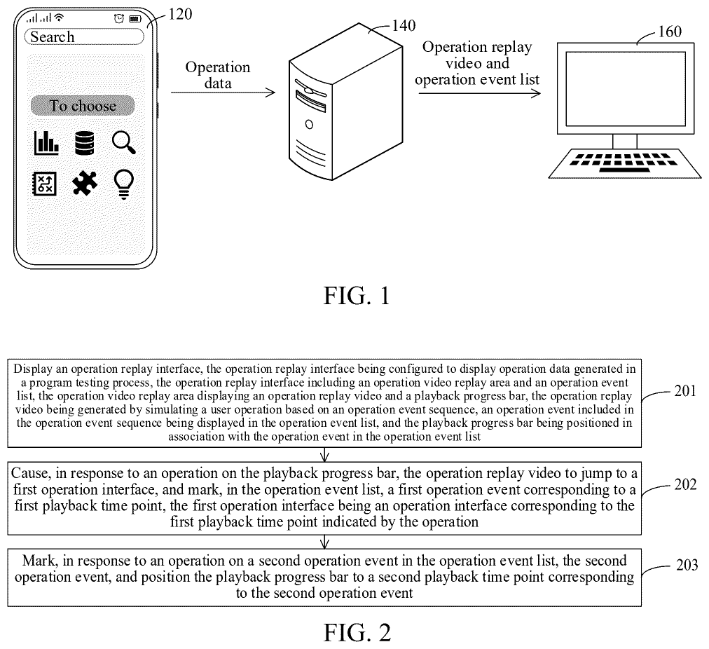

FIG. 1 is a schematic diagram showing an implementation environment according to an aspect of this disclosure. The implementation environment includes a first terminal 120, a server 140, and a second terminal 160. The first terminal 120 performs data communication with the server 140 through a communication network. The second terminal 160 performs data communication with the server 140 through a communication network. In some aspects, the communication network may be a wired network or a wireless network, and the communication network may be at least one of a local area network, a metropolitan area network, and a wide area network.

The first terminal 120 is an electronic device on which a to-be-tested application is installed. The electronic device may be a smartphone, a tablet computer, a personal computer, a wearable device, an on-board terminal, or the like. In FIG. 1, a description is provided by using an example in which the first terminal 120 is the smartphone, but this is not limited thereto.

The second terminal 160 is an electronic device on which an application having an operation data display function is installed. The operation data display function may be a function of a native application in the terminal, or a function of a third-party application. The electronic device may be a smartphone, a tablet computer, a personal computer, a wearable device, an on-board terminal, or the like. In FIG. 1, a description is provided by using an example in which the second terminal 160 is the personal computer, but this is not limited thereto.

The server 140 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In this aspect of this disclosure, the server 140 may be a backend server of an application having functions of operation data storage and display.

In a possible implementation, as shown in FIG. 1, data interaction exists between the server 140 and the first terminal 120, and data interaction exists between the server 140 and the second terminal 160. After receiving operation data generated by a tester in a program testing process, the first terminal 120 transmits the operation data to the server 140, so that the server 140 generates an operation event sequence based on the operation data, further generates an operation replay video and an operation event list, and transmits the operation replay video and the operation event list to the second terminal 160. The second terminal 160 displays an operation replay interface, and displays the operation data to a user.

In the operation data display method provided in the aspects of this disclosure, each operation may be performed by a computer device. The computer device is an electronic device having capabilities such as data computing, processing, and storage. Using the solution implementation environment shown in FIG. 1 as an example, the operation data display method may be performed by the second terminal 160 (for example, a client of an application installed and run in the second terminal 160 performs the operation data display method), the operation data display method may be performed by the server 140, or the operation data display method may be performed by the second terminal 160 and the server 140 in cooperation with each other, which is not limited in this disclosure. For ease of description, in the following method aspects, that operations of the operation data display method are performed by a computer device is used for description.

FIG. 2 is a flowchart of an operation data display method according to an aspect of this disclosure. This aspect is described by using an example in which the method is applied to a computer device (including a second terminal 160 and/or a server 140). The method includes the following operations.

Operation 201: Display an operation replay interface, the operation replay interface being configured to display operation data generated in a program testing process, the operation replay interface including an operation video replay area and an operation event list, the operation video replay area displaying an operation replay video and a playback progress bar, the operation replay video being generated by simulating a user operation based on an operation event sequence, an operation event included in the operation event sequence being displayed in the operation event list, and the playback progress bar being positioned in association with the operation event in the operation event list. For example, an operation event sequence is obtained during execution of an application. An operation replay video is generated based on user operations indicated by the operation event sequence. An operation replay interface including an operation video replay area and an operation event list of the operation event sequence is output for display. The operation video replay area includes the operation replay video and a playback progress bar. Operation events are displayed in the operation event list. Display of the operation events in the operation event list is synchronized with the playback progress bar.

After an application developer develops an application and collects operation data generated by a tester in the program testing process, to enable the application developer to modify and adjust the developed application based on test operation data more effectively, an operation replay interface is provided for the application developer. The operation replay interface is configured to display the operation data generated by the tester in the program testing process.

In some aspects, the operation replay interface includes an operation video replay area and an operation event list. An operation replay video and a playback progress bar are displayed in the operation video replay area, and the operation replay video is generated by simulating a user operation based on an operation event sequence. The operation event included in the operation event sequence is displayed in the operation event list.

In some aspects, the operation replay video may be generated by simulating the user operation based on the operation event sequence in advance before the user views the operation data, or may be generated by simulating the user operation in real time during video playback, which is not limited in this aspect of this disclosure.

In some aspects, the operation event sequence is an event sequence formed by operation events generated based on the user operation in the program testing process. In some aspects, the operation event may include a user interface (UI) change event, a control interaction event, and the like, for example, a keyboard height change, a clicking/tapping operation, and a clicking/tapping jump change, which is not limited in this aspect of this disclosure.

Different from the related art, a user can adjust a playback progress of the operation replay video only by clicking/tapping the playback progress bar. In a case that an operation event corresponding to a current video playback time point needs to be viewed, a corresponding operation event in the operation event list can only be manually browsed and searched for, causing a problem of cumbersome operations of viewing the operation data. In this aspect of this disclosure, the playback progress bar and the operation event in the operation event list are associatively positioned, so that during playback of the operation replay video, the operation event corresponding to the current playback time point may be marked and displayed in the operation event list based on the playback time point corresponding to the playback progress bar.

In some aspects, the operation event displayed in the operation event list may be displayed in a form of a control. Related information such as an event name corresponding to the operation event and a playback time point corresponding to the operation event in the operation replay video may be further displayed in the control, which is not limited in this aspect of this disclosure.

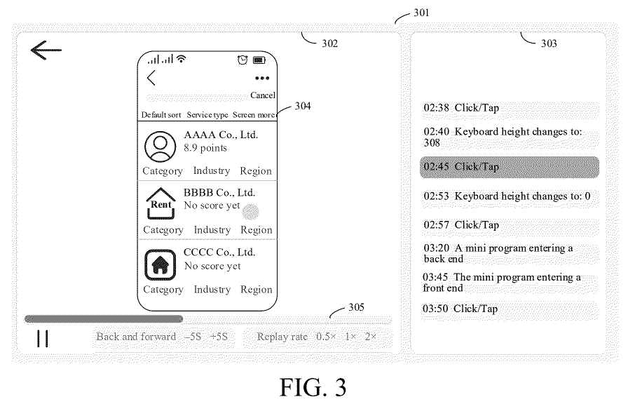

For example, as shown in FIG. 3, the computer device displays an operation replay interface 301. The operation replay interface 301 includes an operation video replay area 302 and an operation event list 303. An operation replay video 304 and a playback progress bar 305 are displayed in the operation video replay area 302. The playback progress bar 305 is positioned in association with an operation event in the operation event list 303.

Operation 202: Cause, in response to a first trigger operation on the playback progress bar, the operation replay video to jump to a first operation interface, and mark, in the operation event list, a first operation event corresponding to a first playback time point, the first operation interface being an operation interface corresponding to the first playback time point indicated by the first trigger operation. For example, based on a first trigger operation being performed on the playback progress bar, a playback indicator of the playback progress bar is positioned at a first playback time point indicated by the first trigger operation. In the operation event list, a display attribute of a first operation event that corresponds to the first playback time point is changed. The operation replay video is played back at the first playback time point.

In a possible implementation, in a case that the first trigger operation on the playback progress bar is received, the computer device may cause, based on the first trigger operation, the operation replay video to jump to the first operation interface corresponding to the first playback time point indicated by the first trigger operation.

In some aspects, the first trigger operation may be a clicking/tapping operation, a dragging operation, or the like on the playback progress bar.

In a possible implementation, in a case that the operation replay video is generated by simulating a user operation in real time during video playback, after the first trigger operation is received, the computer device first determines the first playback time point corresponding to the first trigger operation, and further simulates the user operation based on the operation event sequence until the first operation interface corresponding to the first playback time point is reached starting from a currently displayed operation interface, so that the computer device causes the operation replay video to jump to the first operation interface.

In a possible implementation, to help the user search for the first operation event corresponding to the first playback time point, after receiving the first trigger operation on the playback progress bar and determining the first operation event corresponding to the first playback time point, the computer device may further mark the first operation event in the operation event list.

In some aspects, the marking manner may be performing color marking, magnifying displaying, or the like on the first operation event. A specific marking manner is not limited in this aspect of this disclosure.

Operation 203: Mark, in response to a second trigger operation on a second operation event in the operation event list, the second operation event, and position the playback progress bar to a second playback time point corresponding to the second operation event. For example, based on a second trigger operation being performed on a second operation event in the operation event list, a display attribute of the second operation event in the operation event list is changed. The playback indicator of the playback progress bar is positioned at a second playback time point corresponding to the second operation event.

In a possible implementation, in a case that the second trigger operation on the second operation event in the operation event list is received, the computer device may mark and display the second operation event. In addition, to help the user view the user operation video data corresponding to the second operation event, the computer device may further position the playback progress bar to the second playback time point corresponding to the second operation event, so as to continue to play the operation replay video from the second playback time point.

In some aspects, the second trigger operation may be a clicking/tapping operation, a double-clicking operation, a long-pressing operation, or the like for the second operation event, which is not limited in this aspect of this disclosure.

Based on the above, in the aspects of this disclosure, the operation data generated in the program testing process is displayed through the operation replay interface. The operation replay interface includes the operation video replay area and the operation event list, the operation replay video and the playback progress bar are displayed in the operation video replay area, the operation event is displayed in the operation event list, and the playback progress bar is positioned in association with the operation event. In this way, in a case that the first trigger operation on the playback progress bar is received, the operation replay video may be jumped the first operation interface corresponding to the first playback time point specified by the first trigger operation, and the first operation event corresponding to the first playback time point in the operation event list may further be marked. In a case that the second trigger operation performed on the second operation event in the operation event list is received, the second operation event can be marked, and the playback progress bar may further be positioned to the second playback time point corresponding to the second operation event. In this way, jumping the operation replay video is implemented, bidirectional association positioning between the operation event list and the playback progress bar is implemented, an operation data display effect is optimized, an operation data display manner is enriched, and operation data display efficiency is improved. The user does not need to switch between the video progress bar and the operation event list, and can directly determine the operation event corresponding to a current playback time point, which is simpler in operation and consumes less time.

In a possible implementation, to more accurately implement association positioning between the playback progress bar and the operation event in the operation data display process, the computer device further needs to determine, based on a correspondence between the playback time point corresponding to the playback progress bar and each operation event in the operation event sequence, the corresponding playback time point and operation event under the current trigger operation.

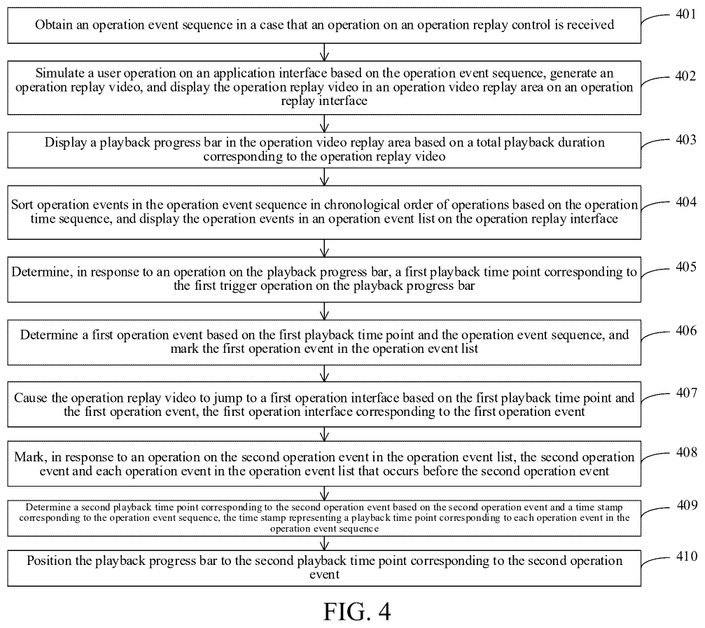

FIG. 4 is a flowchart of an operation data display method according to an aspect of this disclosure. This aspect is described by using an example in which the method is applied to a computer device (including a second terminal 160 and/or a server 140). The method includes the following operations.

Operation 401: Obtain an operation event sequence in a case that a third trigger operation on an operation replay control is received. For example, the operation event sequence is obtained based on a third trigger operation.

In a possible implementation, to help a user view operation data generated in a test process, the computer device may further be provided with an operation replay control, so that the computer device needs to obtain the operation event sequence in a case that the third trigger operation on the operation replay control is received.

In a possible implementation, the computer device may further provide an operation data selection window for the user, so that the user may determine a start operation event and an end operation event in the operation event sequence. In this way, the computer device may directly obtain an operation event sequence based on the start operation event and the end operation event.

Operation 402: Simulate a user operation on an application interface based on the operation event sequence, generate an operation replay video, and display the operation replay video in an operation video replay area on an operation replay interface. For example, user operations on an application interface are simulated based on the operation event sequence to generate the operation replay video.

In a possible implementation, after the operation event sequence is obtained, the computer device may simulate the user operation on the application interface based on the operation event sequence, so as to generate the operation replay video and display the operation replay video in the operation video replay area on the operation replay interface.

In a possible implementation, the computer device may first map an initial UI state of an application interface based on application code, so as to sequentially perform user operation simulation on each operation event based on an operation time sequence on the application interface in the initial UI state according to the operation event sequence, to obtain the operation replay video.

In a possible implementation, the computer device may further directly display the generated operation replay video in real time in the operation video replay area in a process of performing the user operation simulation.

Operation 403: Display a playback progress bar in the operation video replay area based on a total playback duration corresponding to the operation replay video. For example, the playback progress bar in the operation video replay area is displayed based on a total playback duration of the operation replay video.

In some aspects, to help the user adjust a playback progress of the operation replay video, the computer device may further set the playback progress bar for the operation replay video.

In a possible implementation, the computer device determines, based on the total playback duration corresponding to the operation replay video and a display length of the playback progress bar, a correspondence between a display progress of the playback progress bar and a video playback duration, and displays the playback progress bar in the video playback area, where the display progress of the playback progress bar is in a positive correlation with the playback duration of the operation replay video.

Operation 404: Sort operation events in the operation event sequence in chronological order of operations based on the operation time sequence, and display the operation events in an operation event list on the operation replay interface. For example, the operation events are chronologically sorted based on an operation time sequence. The sorted operation events in the operation event list are displayed on the operation replay interface.

In a possible implementation, to correspond to a video playback sequence of the operation replay video, each operation event is displayed in sequence in the operation event list. The computer device may sort the operation events in the operation event sequence in chronological order of operations based on the operation time sequence, and display the operation events in the operation event list on the operation replay interface.

In some aspects, to help the user view a playback time point corresponding to each operation event, the computer device may further display, in the operation event list, the playback time point of each operation event in the operation replay video.

Through at least one operation of the foregoing operations 401 to 404, the operation replay interface is displayed, the operation video replay area and the operation event list are displayed in the operation replay interface, and the playback progress bar in the operation video replay area is positioned in association with an operation event in the operation event list, to provide an implementation basis for marking a first operation event based on an operation performed on the playback progress bar and positioning a second playback time point based on a second operation event in this aspect of this disclosure.

In a possible implementation, considering that a plurality of operation events may be generated in a user operation process, but not all operation events help program test and adjustment, for example, the user browses the application interface by sliding up and down an operation, or repeatedly refreshes an operation for a plurality of times, to simplify the operation event list and improve display efficiency of the operation event in the operation event list, the computer device may further screen the operation events in the operation event sequence to obtain screened operation events, sort the screened operation events based on the operation time sequence, and display the screened operation events in the operation event list.

In some aspects, the screened operation event may include an interface change event and a control interaction event. The interface change event is an operation event that generates an interface jump, and the control interaction event is an operation event that performs interaction by clicking/tapping a corresponding control.

Operation 405: Determine, in response to a first trigger operation on the playback progress bar, a first playback time point corresponding to the first trigger operation on the playback progress bar. For example, based on a first trigger operation being performed on the playback progress bar, a playback indicator of the playback progress bar is positioned at a first playback time point indicated by the first trigger operation.

In a possible implementation, in a case that the first trigger operation on the playback progress bar is received, the computer device first obtains a progress trigger point that corresponds to the first trigger operation on the playback progress bar, so as to determine, based on the display progress corresponding to the progress trigger point, a total display progress of the playback progress bar, and a total playback duration of the operation replay video, the first playback time point that corresponds to the first trigger operation on the playback progress bar.

For example, if the total display progress of the playback progress bar is L, the display progress corresponding to the progress trigger point is p, the total playback duration of the operation replay video is T, the first playback time point may be represented as t_{c}=p/L*T.

Operation 406: Determine a first operation event based on the first playback time point and the operation event sequence, and mark the first operation event in the operation event list. For example, in the operation event list, a display attribute of a first operation event that corresponds to the first playback time point is changed.

In a possible implementation, after the first playback time point is determined, the computer device may determine the first operation event corresponding to the first playback time point based on the first playback time point and the operation event sequence, so as to mark the first operation event in the operation event list.

In a possible implementation, the computer device may determine the first operation event from the operation event sequence though binary search based on the first playback time point and a time stamp corresponding to the operation event sequence, the time stamp representing a playback time point corresponding to each operation event in the operation event sequence.

For example, the process of the binary search is as follows.

1. Initialize left and right boundaries, and let a left boundary l=0 and a right boundary r=n−1 (the setting means letting a left boundary of an instruction be equal to an index of a first operation event in an operation event sequence, and letting the right boundary be equal to an index of a last operation event in the operation event sequence), n being a length of the operation event sequence (i.e., a quantity of operation events included in the operation event sequence).

2. Perform the following operations when l≤r:
a. calculating an intermediate index: m=[(l+r)/2]; and
b. comparing a time stamp tₘ corresponding to each operation event in the operation event sequence with a first playback time point t_{c}:
a) return m if tₘ=t_{c}, namely, the first operation event is an m^{th} operation event in the operation event sequence;
b) update the left boundary if tₘ<t_{c}, let l=m+1, and re-perform the process from the foregoing operation 2; and
c) update the right boundary if tₘ>t_{c}, let r=m−1, and re-perform the process from the foregoing operation 2.

3. Return a first index, the first index being an index of an operation event whose first time stamp is greater than (or less than, which also needs to be determined based on setting of a time stamp herein) the first playback time point, namely, an index of an operation event whose time stamp is closest to the first playback time point.

In a possible implementation, the time stamp of the operation event may be a playback time point when the operation event starts to be played, or may be a playback time period during which the operation event is played, or may be any playback time point in the playback time period during which the operation event is played, which is not limited in this disclosure. Different settings of the time stamp may have impact on the foregoing process of determining the first operation event though the binary search. The specific implementation needs to be determined based on an actual situation.

The first operation event is determined though the binary search, which has a simple solution, requires a small amount of data for calculation, puts less pressure on a computer device, and is more conducive to supporting real-time determination of the first operation event.

In some aspects, to help the user distinguish between a played operation event and an unplayed operation event in the operation event list, the computer device may further mark the played operation event in a manner of color coding. In a possible implementation, when the user performs a video playback jump by triggering the playback progress bar, after the first operation event is determined, the computer device may mark the first operation event in the operation event list and each operation event occurring before the first operation event.

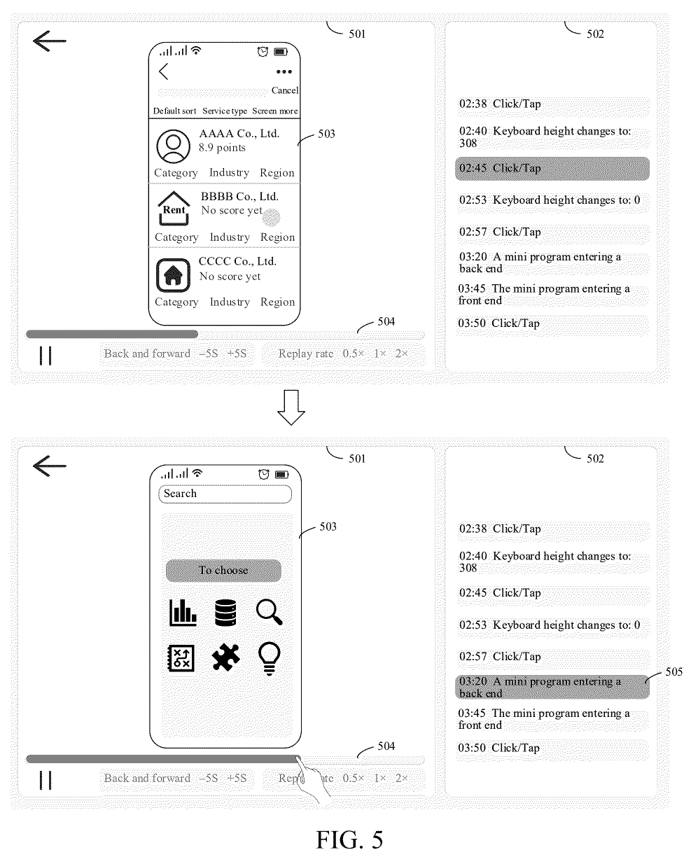

For example, as shown in FIG. 5, in a case that a clicking/tapping operation performed by a user on a playback progress bar 504 in an operation video replay area 501 is received, the computer device determines a first playback time point, to determine a first operation event 505 corresponding to the first playback time point, and marks the first operation event 505 in an operation event list 502.

Operation 407: Cause the operation replay video to jump to the first operation interface based on the first playback time point and the first operation event, the first operation interface corresponding to the first operation event. For example, the operation replay video is played back at the first playback time point.

In a possible implementation, after the first playback time point and the first operation event are determined, the computer device may determine the first operation interface corresponding to the first operation event, so as to cause the operation replay video to jump to the first operation interface.

For example, as shown in FIG. 5, the computer device causes an operation replay video 503 to jump to the first operation interface based on the first playback time point and the first operation event 505.

Through at least one operation of the foregoing operations 405 to 407, the first playback time point corresponding to an operation performed on the playback progress bar may be determined based on the operation, the first operation interface is jumped based on the first playback time point, and the first operation event is determined, to implement an association between the playback progress bar and the first operation event, so that the user can quickly locate a currently played operation event.

Operation 408: Mark, in response to the second trigger operation on the second operation event in the operation event list, the second operation event and each operation event in the operation event list that occurs before the second operation event. For example, based on a second trigger operation being performed on a second operation event in the operation event list, a display attribute of the second operation event in the operation event list is changed.

In a possible implementation, in a case that the second trigger operation performed by the user on the second operation event in the operation event list is received, the computer device may mark the second operation event. For ease of distinguishing each operation event occurring before the second operation event and each operation event occurring after the second operation event, the computer device may further mark and display each operation event occurring before the second operation event.

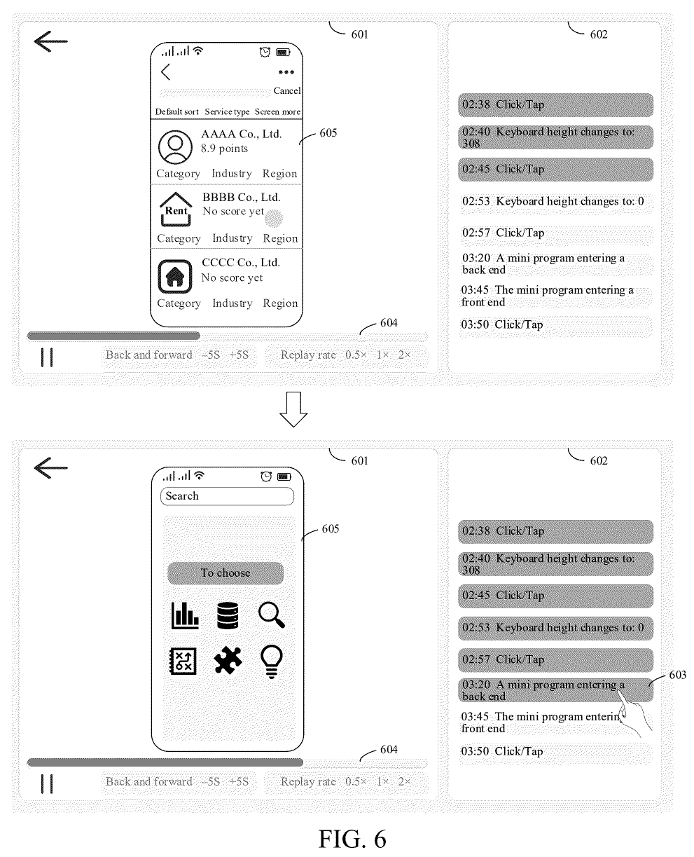

For example, as shown in FIG. 6, in a case that a clicking/tapping operation performed by the user on a second operation event 603 in an operation event list 602 is received, the computer device marks the second operation event 603 and operation events occurring before the second operation event 603.

Operation 409: Determine a second playback time point corresponding to the second operation event based on the second operation event and the time stamp corresponding to the operation event sequence, the time stamp representing a playback time point corresponding to each operation event in the operation event sequence. For example, the second playback time point is determined based on the second operation event and time stamps associated with the operation event sequence. Each time stamp represents a playback time point corresponding to a respective operation event in the operation event sequence.

In a possible implementation, to jump the operation replay video by triggering the second operation event, the computer device further needs to determine the second playback time point corresponding to the second operation event based on the second operation event and the time stamp corresponding to the operation event sequence.

Operation 410: Position the playback progress bar to the second playback time point corresponding to the second operation event. For example, the playback indicator of the playback progress bar is positioned at a second playback time point corresponding to the second operation event.

Further, the computer device positions, based on the total display progress of the playback progress bar, the playback progress bar to the second playback time point corresponding to the second operation event.

In a possible implementation, the computer device determines a display progress corresponding to the second playback time point based on the second playback time point, the total playback duration of the operation replay video, and the total display progress of the playback progress bar, so as to adjust the display progress of the playback progress bar.

For example, if the total display progress of the playback progress bar is L, the second playback time point is t, the total playback duration of the operation replay video is T, the display progress corresponding to the progress trigger point may be represented as pos=t/T*L.

In a possible implementation, after the second playback time point and the second operation event are determined, the computer device may cause the operation replay video to jump to the second operation interface corresponding to the second operation event while the display progress of the playback progress bar is adjusted.

For example, as shown in FIG. 6, after the second operation event 603 is determined, the computer device determines the second playback time point corresponding to the second operation event 603 based on the second operation event 603 and the time stamp corresponding to the operation event sequence, positions a playback progress bar 604 in an operation video replay area 601 to the second playback time point corresponding to the second operation event 603, and causes the operation replay video 605 to jump to the second operation interface corresponding to the second operation event 603.

In the foregoing aspect, in a case that the first trigger operation on the playback progress bar is received, the first operation event in the operation event list may be marked by determining the first playback time point and the first operation event, and the display progress of the playback progress bar is adjusted, to cause the operation replay video to jump to the first operation interface. In addition, in a case that the second trigger operation on the second operation event is received, the second operation event may be marked, the display progress of the playback progress bar is adjusted, and the operation replay video is jumped to the second operation interface, so that bidirectional association positioning is implemented between the operation event list and the playback progress bar, thereby optimizing an operation data display effect.

In a possible implementation, considering that a large quantity of operation events may be generated in a program testing process, if all the operation events are directly displayed in the operation event list, the user may not be able to quickly find a target operation event. Therefore, to improve efficiency of searching for the operation event, the computer device may further hierarchically divide the operation events in the operation event list.

In a possible implementation, after the operation event sequence is obtained, the computer device may perform hierarchical division on the application operation interfaces based on application operation interfaces involved in an operation process according to an interface jump relationship of the application operation interfaces, to obtain a multi-level application operation interface.

In some aspects, an application control in an i^{th} level application operation interface is triggered to jump to an (i+1)^{th} level application operation interface. For example, a main interface of the application may be used as a 1^{st} level application operation interface, and an application interface displayed and jumped by triggering the application control in the main interface may be used as a 2^{nd} level application operation interface, and so on.

Further, the computer device may divide the operation events in the operation event list based on the multi-level application operation interface obtained through division, determine an operation event executed in the i^{th} level application operation interface as an i^{th} level operation event, and display, in the operation event list, the (i+1)^{th} level operation event hierarchically below the i^{th} level operation event.

For example, the operation event executed by the user on the 1^{st} level application operation interface is determined as a 1^{st} level operation event. After jumping from the 1^{st} level application operation interface to the 2^{nd} level application operation interface, an operation event executed on the 2^{nd} level application operation interface is a 2^{nd} level operation event, so that the 2^{nd} level operation event may be displayed below the 1^{st} level operation event in the operation event list.

In some aspects, a display size of the 2^{nd} level operation event may be set to be less than a display size of the 1^{st} level operation event, or the 2^{nd} level operation event may be collapsed, and in a case that a trigger operation on the 1^{st} level operation event is received, the 2^{nd} level operation event is expanded and displayed.

In a possible implementation, in a case that a fourth trigger operation on the i^{th} level operation event is received, the computer device causes the operation replay video to jump to a third operation interface corresponding to the i^{th} level operation event based on the fourth trigger operation. In addition, to help the user view the (i+1)^{th} level operation event in the i^{th} level operation event, the computer device may display, on the playback progress bar, an (i+1)^{th} level playback marking point corresponding to the (i+1)^{th} level operation event corresponding to the i^{th} level operation event. In this way, in response to a fifth trigger operation on the (i+1)^{th} level playback marking point, the computer device may cause the operation replay video to jump to the fourth operation interface corresponding to the (i+1)^{th} level operation event. The operation event is hierarchically displayed based on the application operation interfaces, and the operation events in different application operation interfaces are displayed in different levels, which can effectively help the user quickly position the application operation interface where the operation event locates.

For example, in a case that a clicking/tapping operation on the 1^{st} level operation event is received, the computer device causes the operation replay video to jump to an operation interface corresponding to the 1^{st} level operation event, and displays, on the playback progress bar, a playback marking point corresponding to the 2^{nd} level operation event, so as to help the user quickly view the 2^{nd} level operation event.

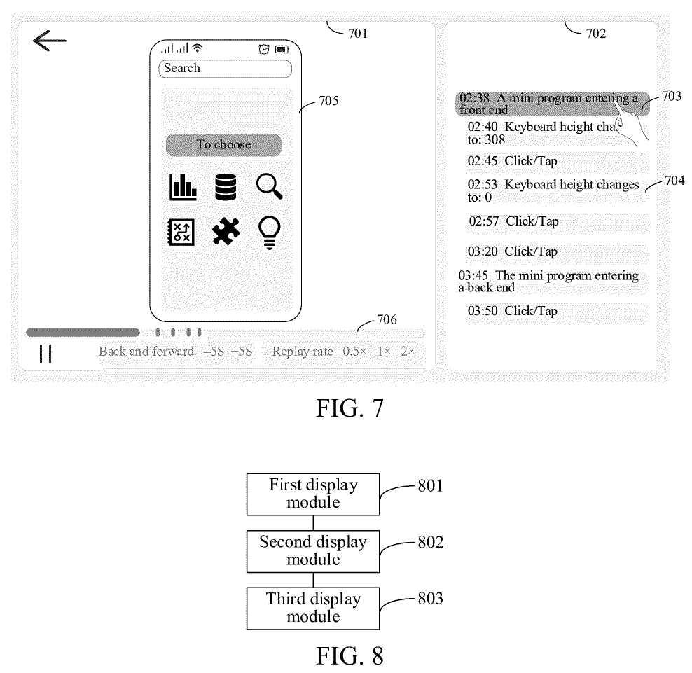

For example, as shown in FIG. 7, in a case that a clicking/tapping operation on a 1^{st} level operation event 703 in an operation event list 702 is received, the computer device causes an operation replay video 705 in an operation video replay area 701 to jump to an operation interface corresponding to the 1^{st} level operation event 703, and displays, on a playback progress bar 706, a playback marking point corresponding to a 2^{nd} level operation event 704.

In the foregoing aspect, application operation interfaces are hierarchically divided, an operation event in each application operation interface is hierarchically divided based on a level division result of the application operation interfaces, and each operation event is displayed in the operation event list based on an event level division result. In this way, a display effect of the operation event list is optimized, and efficiency of viewing the operation data by the user is improved.

In a possible implementation, to help the user view the operation events of the same type through replay, the computer device may further group the operation events based on an operation event sequence and an operation event type, to obtain an operation event grouping result. The operation events of the same type in the operation event grouping result are grouped together. Then the computer device may first display an event group in the operation event list based on the operation event grouping result. In this way, in a case that a sixth trigger operation on the first event group is received, the computer device may expand and display, in the operation event list, each operation event in the first event group.

In a possible implementation, the foregoing manner of hierarchically displaying operation events based on the application operation interfaces and the foregoing manner of grouping and displaying the operation event sequences based on the operation event types may be applied independently or in combination, which is not limited in this disclosure. A specific manner may be determined based on complexity of a program testing process. For example, if the program testing process involves frequent switching between application operation interfaces, the manner of hierarchically displaying the operation events based on the application operation interfaces may be adopted. For example, if the program testing process involves a relatively large quantity of operation events of the same type, the manner of grouping and displaying the operation event sequences based on the operation event types may be adopted. Certainly, the operation event sequences may also be displayed hierarchically first in the manner of hierarchically displaying the operation events based on the application operation interfaces, and the operation event sequences are grouped and displayed based on the operation event types in each level of operation event sequence.

In a possible implementation, to help the user modify program code in time upon finding a program problem while viewing operation data, the computer device may further associate a control interaction event with a control code segment. The control interaction event is an event that implements interface interaction based on a trigger operation on a control.

In a possible implementation, the computer device may screen the operation events for the control interaction event based on the operation event sequence, and display a corresponding control code positioning button in each control interaction event in the operation event list. In this way, in a case that a seventh trigger operation performed by the user on the first control code positioning button is received, the computer device may directly jump and display a first control code segment corresponding to the first control code positioning button in a sequence code corresponding to the operation event sequence.

In a possible implementation, a control code display area is further displayed on the operation replay interface, and the control code display area is configured to display the foregoing first control code segment. For example, in a case that an operation on the first control code positioning button has not been received, the control code display area may be hidden, or the control code display area is blank (namely, no code segment is displayed), or a control code segment corresponding to a currently played operation event is displayed. In a possible implementation, in a case that an operation performed by the user on the first control code positioning button is received, the first control code segment corresponding to the first control code positioning button in the sequence code corresponding to the operation event sequence is jumped and displayed in the operation video replay area. In a possible implementation, in a case that the operation performed by the user on the first control code positioning button is received, a control code display interface is displayed on the operation replay interface in a suspended manner. The control code display interface is configured to display the first control code segment corresponding to the first control code positioning button in the sequence code corresponding to the operation event sequence.

The first control code segment may further be displayed on the operation replay interface in a plurality of manners, which may be displayed on the operation replay interface from the perspective of interface function integration, or may be separately displayed on another interface from the perspective of interface aesthetics.

In a possible implementation, considering that a plurality of testers may participate in the program test, in other words, a plurality of groups of operation event sequences may exist, to improve efficiency of viewing the operation data by the user and switching between a plurality of groups of operation event sequences, the computer device may further display the sequence switching button in the operation video replay area.

In a possible implementation, in a case that an eighth trigger operation performed by the user on the sequence switching button is received, the computer device may switch an operation replay video corresponding to a current operation event sequence in the operation video replay area to an operation replay video corresponding to another operation event sequence, and switch each operation event corresponding to the current operation event sequence in the operation event list to an operation event corresponding to another operation event sequence.

In a possible implementation, the operation video replay area may be displayed in discrete screens. For example, in a case that an operation performed by the user on the sequence switching button is received, an operation replay video corresponding to the first operation event sequence is displayed in a first area in the operation video replay area, and an operation replay video corresponding to the second operation event is displayed in a second area in an operation video restoration area. In this case, the operation events included in the first operation event sequence and the second operation event sequence may be the same, and comparison between the first operation event sequence and the second operation event sequence may be performed on same screens, which can help the user quickly determine a difference between the first operation event sequence and the second operation event sequence, thereby quickly positioning a problem of the application. For example, the first operation event sequence may be a preset standard event sequence, and an operation replay video corresponding to the first operation event sequence is a standard operation replay video. If the operation replay video corresponding to the second operation event sequence is different from the operation replay video corresponding to the first operation event sequence, the operation replay video corresponding to the second operation event sequence has a problem.

FIG. 8 is a structural block diagram of an operation data display apparatus according to an aspect of this disclosure. The apparatus includes:
a first display module 801, configured to display an operation replay interface, the operation replay interface being configured to display operation data generated in a program testing process, the operation replay interface including an operation video replay area and an operation event list, the operation video replay area displaying an operation replay video and a playback progress bar, the operation replay video being generated by simulating a user operation based on an operation event sequence, an operation event included in the operation event sequence being displayed in the operation event list, and the playback progress bar being positioned in association with the operation event in the operation event list;
a second display module 802, configured to cause, in response to a first trigger operation on the playback progress bar, the operation replay video to jump to a first operation interface, and mark, in the operation event list, a first operation event corresponding to a first playback time point, the first operation interface being an operation interface corresponding to the first playback time point indicated by the first trigger operation; and
a third display module 803, configured to mark, in response to a second trigger operation on a second operation event in the operation event list, the second operation event, and position the playback progress bar to a second playback time point corresponding to the second operation event.

In some aspects, the second display module 802 is configured to:
determine, in response to the first trigger operation on the playback progress bar, the first playback time point corresponding to the first trigger operation on the playback progress bar;
determine the first operation event based on the first playback time point and the operation event sequence, and mark the first operation event in the operation event list; and
cause the operation replay video to jump to the first operation interface based on the first playback time point and the first operation event, the first operation interface corresponding to the first operation event.

In some aspects, the second display module 802 is further configured to:
determine the first operation event from the operation event sequence though binary search based on the first playback time point and a time stamp corresponding to the operation event sequence, the time stamp representing a playback time point corresponding to each operation event in the operation event sequence; and
mark the first operation event in the operation event list and each operation event occurring before the first operation event.

In some aspects, the third display module 803 is configured to:
mark, in response to the second trigger operation on the second operation event in the operation event list, the second operation event and each operation event in the operation event list that occurs before the second operation event;
determine a second playback time point corresponding to the second operation event based on the second operation event and the time stamp corresponding to the operation event sequence, the time stamp representing a playback time point corresponding to each operation event in the operation event sequence; and
position the playback progress bar to the second playback time point corresponding to the second operation event.

In some aspects, the third display module 803 is further configured to:
cause the operation replay video to jump to a second operation interface based on the second playback time point and the second operation event, the second operation interface corresponding to the second operation event; and
adjust a display progress of the playback progress bar based on the second playback time point and a total playback duration of the operation replay video, the display progress being positively correlated with a playback duration of the operation replay video.

In some aspects, the first display module 801 is configured to:
obtain the operation event sequence in a case that a third trigger operation on an operation replay control is received;
simulate the user operation on an application interface based on the operation event sequence, generating the operation replay video, and display the operation replay video in the operation video replay area on the operation replay interface;
display the playback progress bar in the operation video replay area based on the total playback duration corresponding to the operation replay video; and
sort operation events in the operation event sequence in chronological order of operations based on the operation time sequence, and display the operation events in the operation event list on the operation replay interface.

In some aspects, the first display module 801 is further configured to:
screen the operation events in the operation event sequence, to obtain a screened operation event, the screened operation event including an interface change event and a control interaction event, the interface change event being an operation event that generates an interface jump, and the control interaction event being an event that implements interface interaction based on a trigger operation on a control; and
sort the screened operation events in chronological order of operations, and display the screened operation events in the operation event list.

In some aspects, the apparatus further includes:
a level division module, configured to hierarchically divide an application operation interface based on the operation event sequence, to obtain a multi-level application operation interface, an application control in an i^{th} level application operation interface being triggered to jump to an (i−1)^{th} level application operation interface;
an event division module, configured to divide, based on the multi-level application operation interface obtained through division, the operation events in the operation event list, and determine, as an i^{th} level operation event, an operation event executed in the i^{th} level application operation interface; and
a fourth display module, configured to hierarchically display, in the operation event list, an (i+1)^{th} level operation event below the i^{th} level operation event.

In some aspects, the apparatus further includes:
a playback jumping module, configured to cause, in response to a fourth trigger operation on the i^{th} level operation event, the operation replay video to jump to a third operation interface corresponding to the i^{th} level operation event; and
a fifth display module, configured to display, on the playback progress bar, an (i+1)^{th} level playback marking point corresponding to the (i+1)^{th} level operation event corresponding to the i^{th} level operation event.

The playback jumping module is further configured to cause, in response to a fifth trigger operation on the (i+1)^{th} level playback marking point, the operation replay video to jump to a fourth operation interface corresponding to the (i+1)^{th} level operation event.

In some aspects, the apparatus further includes:
a grouping module, configured to group the operation events based on the operation event sequence and an operation event type, to obtain an operation event grouping result, operation events of the same type in the operation event grouping result being grouped together;
a sixth display module, configured to display an event group in the operation event list based on the operation event grouping result; and
a seventh display module, configured to expand and display, in response to a sixth trigger operation on a first event group, each operation event in the first event group in the operation event list.

In some aspects, the apparatus further includes:
a screening module, configured to screen the operation events for a control interaction event based on the operation event sequence, the control interaction event being an event that implements interface interaction based on a trigger operation on a control;
an eighth display module, configured to display a corresponding control code positioning button in the control interaction event in the operation event list; and
a ninth display module, configured to jump and display, in response to a seventh trigger operation on a first control code positioning button, a first control code segment corresponding to the first control code positioning button in a sequence code corresponding to the operation event sequence.

In some aspects, a sequence switching button is further displayed on the operation video replay area.

The apparatus further includes:
a switching display module, configured to switch and display, in response to an eighth trigger operation on the sequence switching button, the operation replay video in the operation video replay area, and switch and display the operation event in the operation event list.

Based on the above, in the aspects of this disclosure, the operation data generated in the program testing process is displayed through the operation replay interface. The operation replay interface includes the operation video replay area and the operation event list, the operation replay video and the playback progress bar are displayed in the operation video replay area, the operation event is displayed in the operation event list, and the playback progress bar is positioned in association with the operation event. In this way, in a case that the first trigger operation on the playback progress bar is received, the operation replay video may be jumped the first operation interface corresponding to the first playback time point specified by the first trigger operation, and the first operation event corresponding to the first playback time point in the operation event list may further be marked. In a case that the second trigger operation performed on the second operation event in the operation event list is received, the second operation event can be marked, and the playback progress bar may further be positioned to the second playback time point corresponding to the second operation event, which implement bidirectional association positioning between the operation event list and the playback progress bar and optimizes an operation data display effect, thereby optimizing an operation data display effect, enriching operation data display manners, and improving operation data display efficiency. The user does not need to switch between the video progress bar and the operation event list, and can directly determine the operation event corresponding to a current playback time point, which is simpler in operation and consumes less time.

The apparatus provided in the foregoing aspect is illustrated only with an example of division of the foregoing function modules. In practical applications, the foregoing functions may be allocated to and completed by different function modules according to requirements. In other words, the internal structure of the apparatus is divided into different function modules to complete all or some of the functions described above. In addition, the apparatus provided in the foregoing aspects and the method aspects belong to the same concept. For details of an implementation process, reference may be made to the method aspects. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

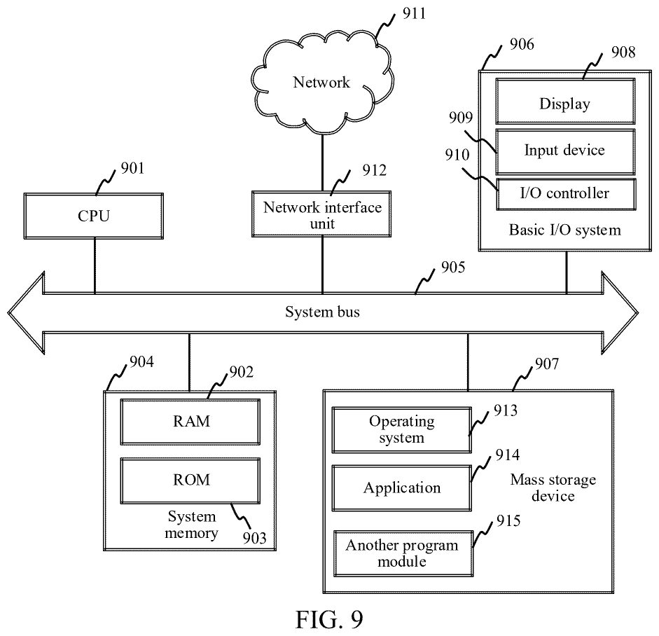

FIG. 9 is a schematic structural diagram of a computer device according to an aspect of this disclosure. For example, the computer device 900 includes processing circuitry, such as a central processing unit (CPU) 901, a system memory 904 including a random access memory 902 and a read-only memory 903, and a system bus 905 connecting the system memory 904 and the central processing unit 901. The computer device 900 further includes a basic input/output (I/O) system 906 assisting in information transmission between devices in the computer, and a mass storage device 907 configured to store an operating system 913, an application 914, and another program module 915.

The basic input/output system 906 includes a display 908 configured to display information and an input device 909 such as a mouse and a keyboard for a user to input information. The display 908 and the input device 909 are both connected to the CPU 901 through an I/O controller 910 connected to the system bus 905. The basic I/O system 906 may further include the I/O controller 910 for receiving and processing input from a plurality of other devices such as a keyboard, a mouse, an electronic stylus, or the like. Similarly, the I/O controller 910 further provides an output to a display screen, a printer, or another type of output device.

The mass storage device 907 is connected to the CPU 901 through a mass storage controller (not shown) connected to the system bus 905. The mass storage device 907 and a computer-readable medium associated with the mass storage device provide non-volatile storage for the computer device 900. In other words, the mass storage device 907 may include a computer-readable medium (not shown) such as a hard disk or a drive.

The computer-readable medium may include a computer storage medium, such as a non-transitory computer-readable storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical memory, a magnetic cassette, a magnetic tape, or another magnetic storage device. Certainly, a person skilled in the art may learn that the computer storage medium is not limited to the foregoing several types. The foregoing system memory 904 and the mass storage device 907 may be collectively referred to as a memory.

The memory has one or more programs stored therein, the one or more programs being configured to be executed by one or more CPUs 901, and the one or more programs including instructions for implementing the foregoing method. The CPU 901 executes the one or more programs to implement the method provided in the foregoing method aspects.

According to the aspects of this disclosure, the computer device 900 may further be connected, through a network such as the Internet, to a remote computer on the network and run. In other words, the computer device 900 may be connected to a network 911 through a network interface unit 912 connected to the system bus 905, or may be connected to another type of network or a remote computer system (not shown) through the network interface unit 912.

An aspect of this disclosure further provides a computer-readable storage medium, having at least one instruction stored therein, the at least one instruction being loaded and executed by a processor to implement the operation data display method provided in the foregoing method aspects.

In some aspects, the computer-readable storage medium may include a ROM, a RAM, a solid state drive (SSD), an optical disc, or the like. The RAM may include a resistance random access memory (ReRAM) and a dynamic random access memory (DRAM).

An aspect of this disclosure provides a computer program product, including computer instruction, the computer instruction being stored in a computer-readable storage medium. A processor of a computer device reads the computer instruction from the computer-readable storage medium, and the processor executes the computer instruction, so that the computer device performs the operation data display method in the foregoing method aspects.

A person of ordinary skill in the art may understand that all or some of the operations of the foregoing aspects may be implemented by hardware, or may be implemented by a program instructing relevant hardware. The program may be stored in a computer-readable storage medium. The storage medium may be a ROM, a magnetic disk, an optical disc, or the like.

The foregoing descriptions are merely some examples of aspects of this disclosure, and are not intended to limit this disclosure. Any modification, equivalent replacement, or improvement made within the spirit and principle of this disclosure shall fall within the scope of this disclosure.

What is claimed is:

1. A method for replaying user operation events, the method comprising:
obtaining an operation event sequence during execution of an application;
generating an operation replay video based on user operations indicated by the operation event sequence;
outputting for display an operation replay interface including an operation video replay area and an operation event list of the operation event sequence, the operation video replay area including the operation replay video and a playback progress bar, operation events being displayed in the operation event list, and display of the operation events in the operation event list being synchronized with the playback progress bar;
based on a first trigger operation being performed on the playback progress bar,
positioning a playback indicator of the playback progress bar at a first playback time point indicated by the first trigger operation,
changing, in the operation event list, a display attribute of a first operation event that corresponds to the first playback time point, and
playing back the operation replay video at the first playback time point; and
based on a second trigger operation being performed on a second operation event in the operation event list,
changing a display attribute of the second operation event in the operation event list, and
positioning the playback indicator of the playback progress bar at a second playback time point corresponding to the second operation event.

2. The method according to claim 1, further comprising:
performing a binary search on the operation event sequence based on the first playback time point and time stamps associated with the operation event sequence, each time stamp representing a playback time point corresponding to a respective operation event in the operation event sequence; and
determining the first operation event corresponding to the first playback time point based on the binary search.

3. The method according to claim 1, further comprising:
determining the second playback time point based on the second operation event and time stamps associated with the operation event sequence, each time stamp representing a playback time point corresponding to a respective operation event in the operation event sequence.

4. The method according to claim 3, wherein the positioning the playback indicator of the playback progress bar at the second playback time point comprises:
adjusting the position of the playback progress bar based on the second playback time point and a total playback duration of the operation replay video.

5. The method according to claim 1, wherein the outputting for display the operation replay interface comprises:
obtaining the operation event sequence based on a third trigger operation;
simulating user operations on an application interface based on the operation event sequence to generate the operation replay video;
outputting for display the operation replay video in the operation video replay area on the operation replay interface;
outputting for display the playback progress bar in the operation video replay area based on a total playback duration of the operation replay video;
sorting the operation events chronologically based on an operation time sequence; and
outputting for display the sorted operation events in the operation event list on the operation replay interface.

6. The method according to claim 5, wherein the sorting the operation events comprises:
selecting the operation events in the operation event sequence to obtain selected operation events, the selected operation events including interface change events and control interaction events, each interface change event initiating a transition from one application interface to another application interface, and each control interaction event representing a trigger operation being performed on a control element; and
sorting the selected operation events chronologically.

7. The method according to claim 1, further comprising:
dividing application operation interfaces based on the operation event sequence to obtain multi-level application operation interfaces, triggering an application control in an i^{th} level application operation interface to initiate a transition to an (i+1)^{th} level application operation interface;
dividing the operation events in the operation event list based on the multi-level application operation interfaces;
determining operation events executed in the i^{th} level application operation interface as i^{th} level operation events; and
outputting for display (i+1)^{th} level operation events below corresponding i^{th} level operation events in the operation event list.

8. The method according to claim 7, further comprising:
based on a fourth trigger operation being performed on an i^{th} level operation event, setting a playback position of the operation replay video to a third playback time point corresponding to the i^{th} level operation event;
outputting for display, on the playback progress bar, an (i+1)^{th} level playback marking point corresponding to an (i+1)^{th} level operation event associated with the i^{th} level operation event; and
based on a fifth trigger operation being performed on the (i+1)^{th} level playback marking point, setting the playback position of the operation replay video to a fourth playback time point corresponding to the (i+1)^{th} level operation event.

9. The method according to claim 1, further comprising:
grouping the operation events based on the operation event sequence and operation event types to obtain an operation event grouping result, operation events of a same type in the operation event grouping result being grouped together; and
outputting for display event groups in the operation event list based on the operation event grouping result.

10. The method according to claim 1, further comprising:
selecting the operation events for control interaction events based on the operation event sequence, each control interaction event corresponding to a respective trigger operation being performed on a respective control element;
outputting for display a control code positioning element for each control interaction event in the operation event list; and
based on a seventh trigger operation being performed on a first control code positioning element of the control code positioning elements, retrieving and outputting for display a control code segment corresponding to the first control code positioning element in a source code corresponding to the operation event sequence.

11. The method according to claim 1, further comprising:
outputting for display a sequence switching element in the operation video replay area; and
based on an eighth trigger operation being performed on the sequence switching element, switching the operation replay video in the operation video replay area to a different operation replay video and switching the operation events displayed in the operation event list to operation events corresponding to the different operation replay video.

12. An apparatus for replaying user operation events, the apparatus comprising:
processing circuitry configured to:
obtain an operation event sequence during execution of an application;
generate an operation replay video based on user operations indicated by the operation event sequence;
output for display an operation replay interface including an operation video replay area and an operation event list of the operation event sequence, the operation video replay area including the operation replay video and a playback progress bar, operation events being displayed in the operation event list, and display of the operation events in the operation event list being synchronized with the playback progress bar;
based on a first trigger operation being performed on the playback progress bar,
position a playback indicator of the playback progress bar at a first playback time point indicated by the first trigger operation,
change, in the operation event list, a display attribute of a first operation event that corresponds to the first playback time point, and
play back the operation replay video at the first playback time point; and
based on a second trigger operation being performed on a second operation event in the operation event list,
change a display attribute of the second operation event in the operation event list, and
position the playback indicator of the playback progress bar at a second playback time point corresponding to the second operation event.

13. The apparatus according to claim 12, wherein the processing circuitry is configured to:
perform a binary search on the operation event sequence based on the first playback time point and time stamps associated with the operation event sequence, each time stamp representing a playback time point corresponding to a respective operation event in the operation event sequence; and
determine the first operation event corresponding to the first playback time point based on the binary search.

14. The apparatus according to claim 12, wherein the processing circuitry is configured to:
determine the second playback time point based on the second operation event and time stamps associated with the operation event sequence, each time stamp representing a playback time point corresponding to a respective operation event in the operation event sequence.

15. The apparatus according to claim 14, wherein the processing circuitry is configured to:
adjust the position of the playback progress bar based on the second playback time point and a total playback duration of the operation replay video.

16. The apparatus according to claim 12, wherein the processing circuitry is configured to:
obtain the operation event sequence based on a third trigger operation;
simulate user operations on an application interface based on the operation event sequence to generate the operation replay video;
output for display the operation replay video in the operation video replay area on the operation replay interface;
output for display the playback progress bar in the operation video replay area based on a total playback duration of the operation replay video;
sort the operation events chronologically based on an operation time sequence; and
output for display the sorted operation events in the operation event list on the operation replay interface.

17. The apparatus according to claim 16, wherein the processing circuitry is configured to:
select the operation events in the operation event sequence to obtain selected operation events, the selected operation events including interface change events and control interaction events, each interface change event initiating a transition from one application interface to another application interface, and each control interaction event representing a trigger operation being performed on a control element; and
sort the selected operation events chronologically.

18. The apparatus according to claim 12, wherein the processing circuitry is configured to:
divide application operation interfaces based on the operation event sequence to obtain multi-level application operation interfaces, triggering an application control in an i^{th} level application operation interface to initiate a transition to an (i+1)^{th} level application operation interface;
divide the operation events in the operation event list based on the multi-level application operation interfaces;
determine operation events executed in the i^{th} level application operation interface as i^{th} level operation events; and
output for display (i+1)^{th} level operation events below corresponding i^{th} level operation events in the operation event list.

19. The apparatus according to claim 18, wherein the processing circuitry is configured to:
based on a fourth trigger operation being performed on an i^{th} level operation event, set a playback position of the operation replay video to a third playback time point corresponding to the i^{th} level operation event;
output for display, on the playback progress bar, an (i+1)^{th} level playback marking point corresponding to an (i+1)^{th} level operation event associated with the i^{th} level operation event; and
based on a fifth trigger operation being performed on the (i+1)^{th} level playback marking point, set the playback position of the operation replay video to a fourth playback time point corresponding to the (i+1)^{th} level operation event.

20. A non-transitory computer-readable storage medium storing instructions which, when executed by a processor, cause the processor to perform:
obtaining an operation event sequence during execution of an application;
generating an operation replay video based on user operations indicated by the operation event sequence;
outputting for display an operation replay interface including an operation video replay area and an operation event list of the operation event sequence, the operation video replay area displaying the operation replay video and a playback progress bar, operation events being displayed in the operation event list, and display of the operation events in the operation event list being synchronized with the playback progress bar;
based on a first trigger operation being performed on the playback progress bar,
positioning a playback indicator of the playback progress bar at a first playback time point indicated by the first trigger operation,
changing, in the operation event list, a display attribute of a first operation event that corresponds to the first playback time point, and
playing back the operation replay video at the first playback time point; and
based on a second trigger operation being performed on a second operation event in the operation event list,
changing a display attribute of the second operation event in the operation event list, and
positioning the playback indicator of the playback progress bar at a second playback time point corresponding to the second operation event.
